(19) United States
(12) Patent Application Publication
(10) Pub. No.: US 2026/0060331 A1
(43) Pub. Date: Mar. 5, 2026

(54) HEATING ELEMENT, HEAT-NOT-BURN DEVICE, AND HEATING CONTROL METHOD THEREFOR

(71) Applicant: SMOORE INTERNATIONAL HOLDINGS LIMITED, George Town (KY)

(72) Inventors: Shiyuan LIU, Shenzhen (CN); Lei MA, Shenzhen (CN); Xianwu DU, Shenzhen (CN); Hengheng DOU, Shenzhen (CN); Xiangzhong LI, Shenzhen (CN); Rihong LI, Shenzhen (CN); Hongming ZHOU, Shenzhen (CN); Pengchong ZHANG, Shenzhen (CN)

(21) Appl. No.: 19/383,431

(22) Filed: Nov. 7, 2025

Related U.S. Application Data
(63) Continuation of application No. PCT/CN2024/091480, filed on May 7, 2024.

(30) Foreign Application Priority Data
May 9, 2023 (CN) 202310525498.2

(51) Int. Cl. A24F 40/57; A24F 40/20; A24F 40/46; H05B 3/44

(52) U.S. Cl. CPC A24F 40/57; A24F 40/46; H05B 3/44; A24F 40/20; H05B 2203/032

(57) ABSTRACT

A heating control method for a heat-not-burn device that includes a heating element for heating an aerosol-forming substrate includes: controlling the heating element so as to increase from an initial temperature to a first temperature when heating is started, and maintaining the first temperature; controlling the heating element so as to increase from a current temperature to a second temperature when detecting a puffing action, the second temperature being greater than the first temperature; and controlling the heating element so as to decrease from a current temperature to a third temperature when detecting that the puffing action ends, the third temperature being less than the second temperature.

### CROSS-REFERENCE TO PRIOR APPLICATION

This application is a continuation of International Patent Application No. PCT/CN2024/091480, filed on May 7, 2024, which claims priority to Chinese Patent Application No. 202310525498.2, filed on May 9, 2023. The entire disclosure of both applications is hereby incorporated by reference herein.

### FIELD

The present invention relates to the atomization field, and in particular, to a heating element, a heat-not-burn device, and a heating control method therefor.

### BACKGROUND

In a heat-not-burn device, an aerosol-forming substrate is generally continuously heated at a high temperature. As shown in FIG. 1, a temperature after preheat is continuously maintained above 350° C., and the aerosol-forming substrate is continuously in a state of generating aerosols. Therefore, a user needs to complete vaping within a short time (for example, 4 to 5 minutes). However, personal habits of users are different, and some users may have a relatively long break during vaping. If an aerosol-forming substrate is still heated at a high temperature during the break, most of the aerosol-forming substrate is lost, and the taste is affected. Therefore, experience of vapers is relatively poor. In addition, there is a problem of inconsistent taste in start and end periods of continuous heating at a high temperature. Due to continuous heating, there are problems such as smell of burning or insufficient fumes in the end period. Besides, energy consumption of continuous heating is relatively high.

### SUMMARY

In an embodiment, the present invention provides a heating control method for a heat-not-burn device that includes a heating element for heating an aerosol-forming substrate, the method comprising: controlling the heating element so as to increase from an initial temperature to a first temperature when heating is started, and maintaining the first temperature; controlling the heating element so as to increase from a current temperature to a second temperature when detecting a puffing action, the second temperature being greater than the first temperature; and controlling the heating element so as to decrease from a current temperature to a third temperature when detecting that the vaping action ends, the third temperature being less than the second temperature.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram of an existing heating control curve of an aerosol-forming substrate;

FIG. 2 is a flowchart of a heating control method for a heat-not-burn device according to Embodiment 1 of the present invention;

FIG. 3 is a diagram of a heating control curve of an aerosol-forming substrate according to an embodiment of the present invention;

FIG. 4 is a diagram of a heating control curve of an aerosol-forming substrate according to another embodiment of the present invention;

FIG. 5 is a diagram of a heating control curve of an aerosol-forming substrate according to still another embodiment of the present invention;

FIG. 6 is a structural diagram of a heat-not-burn device according to a first embodiment of the present invention;

FIG. 7 is a schematic structural diagram of a heating element in the heat-not-burn device shown in FIG. 6;

FIG. 8 is a sectional view of the heating element shown in FIG. 7;

FIG. 9 is a schematic structural exploded view of the heating element shown in FIG. 7;

FIG. 10 is a schematic structural diagram of a heating element in a heat-not-burn device according to a second embodiment of the present invention;

FIG. 11 is a schematic structural diagram of the heating element shown in FIG. 10 from another angle;

FIG. 12 is a sectional view of the heating element shown in FIG. 10; and

FIG. 13 is a schematic structural exploded view of the heating element shown in FIG. 10.

### DETAILED DESCRIPTION

In an embodiment, the present invention provides a heating control method for a heat-not-burn device, where the heat-not-burn device includes a heating element, and the heating element is configured to heat an aerosol-forming substrate. In an embodiment, the method includes:
controlling the heating element to increase from an initial temperature to a first temperature when heating is started, and maintaining the first temperature;
controlling the heating element to increase from a current temperature to a second temperature when detecting a vaping action, where the second temperature is greater than the first temperature; and
controlling the heating element to decrease from a current temperature to a third temperature when detecting that the vaping action ends, where the third temperature is less than the second temperature.

Preferably, the heating element heats the aerosol-forming substrate through infrared radiation, the heating element includes a heating body and a tube element, the heating body includes a heating substrate and an infrared radiation layer disposed on an outer surface of the heating substrate, the heating substrate is configured to be powered on for heating and excite the infrared radiation layer to radiate infrared light, the heating body is at least partially spaced from the tube wall of the tube element, the tube wall of the tube element allows the infrared light to penetrate through, and the infrared light is configured to heat the aerosol-forming substrate.

Preferably, a wavelength of the infrared light includes at least a band of 2 μm to 4.75 μm.

Preferably, the first temperature is 100° C. to 300° C.; and/or
the second temperature is 300° C. to 400° C.; and/or
the third temperature is 100° C. to 300° C.

Preferably, the first temperature is 180° C. to 280° C.; and/or
the second temperature is 300° C. to 380° C.; and/or
the third temperature is 180° C. to 280° C.

Preferably, the first temperature is 200° C. to 260° C.; and/or
the second temperature is 330° C. to 360° C.; and/or
the third temperature is 200° C. to 260° C.

Preferably, the method further includes:
controlling a first timer to start timing when heating is started;
controlling the first timer to stop timing when detecting the first vaping action, and determining a preheat time according to a time of the first timer; and
determining, according to the preheat time, the second temperature corresponding to the first vaping action, where the second temperature corresponding to the first vaping action is negatively correlated to a temperature increase time of the preheat time.

Preferably, the method further includes:
controlling a second timer to start timing when detecting that an (i-1)^{th} vaping action ends;
controlling the second timer to stop timing when detecting an i^{th} vaping action, and determining a heat preserving time according to a time of the second timer, where i=2, 3, . . .; and
determining, according to the heat preserving time, the second temperature corresponding to the i^{th} vaping action, where the second temperature corresponding to the i^{th} vaping action is positively correlated to the heat preserving time.

Preferably, the method further includes:
collecting statistics on a current total number of times of vaping and/or an accumulated heating time when detecting that the vaping action ends; and
determining the third temperature according to the total number of times of vaping and/or the accumulated heating time.

Preferably, the step of determining, according to the preheat time, the second temperature corresponding to the first vaping action includes:
determining whether the temperature increase time of the preheat time is less than a first preset time; and
determining the second temperature corresponding to the first vaping action as a first specific value if the temperature increase time is less than the first preset time; or
determining the second temperature corresponding to the first vaping action as a second specific value if the temperature increase time is not less than the first preset time, where the second specific value is less than the first specific value.

Preferably, the step of determining, according to the heat preserving time, the second temperature corresponding to the i^{th} vaping action includes:
determining whether the heat preserving time is less than a second preset time; and
determining the second temperature corresponding to the i^{th} vaping action as a third specific value if the heat preserving time is less than the second preset time; or
determining the second temperature corresponding to the i^{th} vaping action as a fourth specific value if the heat preserving time is not less than the second preset time, where the fourth specific value is greater than the third specific value.

Preferably, the step of controlling the heating element includes:
obtaining, in real time, a temperature detected by a temperature measurement module, to obtain a detected temperature value;
obtaining a target temperature value, where the target temperature value is the first temperature when heating is started; the target temperature value is the second temperature when the vaping action is detected; and the target temperature value is the third temperature when it is detected that the vaping action ends; and
performing PID calculation on the detected temperature value and the target temperature value, and controlling the heating element according to a PID calculation result.

Preferably, the method further includes:
stopping control on the heating element when determining that a preset stop condition is met, where the preset stop condition includes at least one of the following:
a total number of times of vaping reaches a preset number of times;
an accumulated heating time reaches a third preset time; and
a stop instruction inputted by a user is received.

The present invention further constructs a computer storage medium, storing a computer program, where the computer program, when executed by a processor, implements the steps of the heating control method of a heat-not-burn device described above.

The present invention further constructs a heat-not-burn device, including a processor and a memory storing a computer program, where when executing the computer program, the processor implements the steps of the heating control method of a heat-not-burn device described above.

The present invention further constructs a heating element, including a heating body and a tube element, where the heating body is powered on for heating according to the foregoing heating control method and is configured to radiate infrared light, the heating body is at least partially spaced from the tube wall of the tube element, the tube wall of the tube element allows the infrared light to penetrate through, and the infrared light is configured to heat an aerosol-forming substrate.

Preferably, the heating body includes a heating substrate and an infrared radiation layer disposed on an outer surface of the heating substrate, where the heating substrate is powered on for heating and is configured to excite the infrared radiation layer to radiate infrared light.

Preferably, the tube element is configured to be at least partially inserted into an aerosol-forming substrate and includes a body portion and a tip portion disposed at one end of the body portion, and the heating element is spaced from the inner wall of the body portion.

Preferably, the heating body is disposed in the periphery of the tube element, an accommodating cavity is disposed in the tube element, and the aerosol-forming substrate is at least partially accommodated in the accommodating cavity.

### Technical Problem

A technical problem to be resolved by the present invention is a technical defect in the prior art that a user cannot vape at any time.

### Beneficial Effect

According to the technical solutions of the present invention, through temperature control on the heating element, low-temperature (the first temperature) preheating and low-temperature (the third temperature) heat preserving may be performed on the aerosol-forming substrate. High-temperature (the second temperature) heating is performed only when a vaping action occurs. Therefore, even if a user randomly vapes for a long time, during the low-temperature preheating and the low-temperature heat preserving, the aerosol-forming substrate is not mostly carbonized, and a small portion of the aerosol-forming substrate is lost. Therefore, the user is not required to complete vaping within approximately five minutes, so that the user can vape at any time and user experience is improved. In addition, it can be avoided that the aerosol-forming substrate is charred during continuous high-temperature heating, and the consistency of taste can be ensured.

The following clearly and completely describes the technical solutions in the embodiments of the present invention with reference to the accompanying drawings in the embodiments of the present invention. Apparently, the described embodiments are some of the embodiments of the present invention rather than all of the embodiments. All other embodiments obtained by a person of ordinary skill in the art based on the embodiments of the present invention without creative efforts shall fall within the protection scope of the present invention.

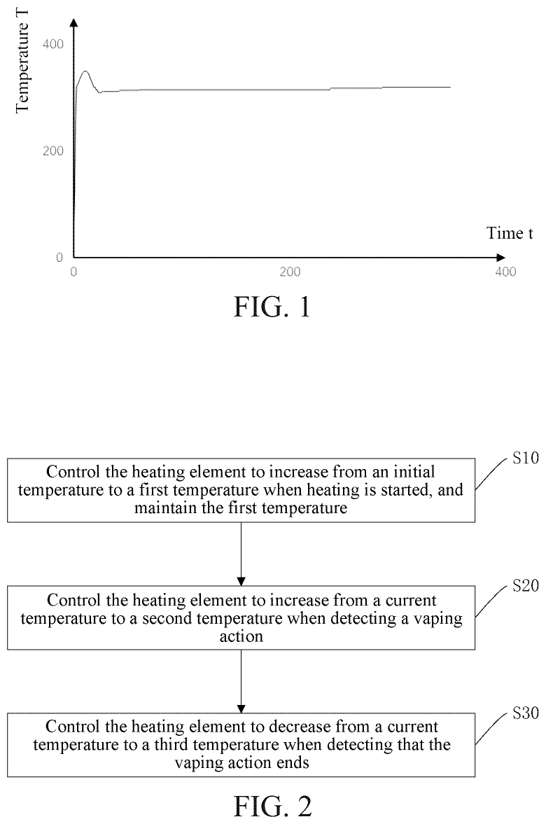

FIG. 2 is a flowchart of a heating control method for a heat-not-burn device according to Embodiment 1 of the present invention. The heating control method of this embodiment is applied to a processor of the heat-not-burn device. The heat-not-burn device further includes a heating element, a power supply, a vaping detection module, a temperature measurement module, and the like. The power supply supplies energy to the heating element. The temperature measurement module is configured to detect a temperature of the heating element. The vaping detection module is configured to detect a vaping action. The heating element is configured to heat an aerosol-forming substrate. The heating element may have a plurality of forms, for example, may be a heating slice, a heating pin, a heating bar, or a heating cable or wire. Alternatively, the heating element may be a combination of the heating components in the foregoing two or more different forms.

As shown in FIG. 2, the heating control method for a heat-not-burn device in this embodiment includes the following steps:
Step S10: Control the heating element to increase from an initial temperature to a first temperature when heating is started, and maintain the first temperature.

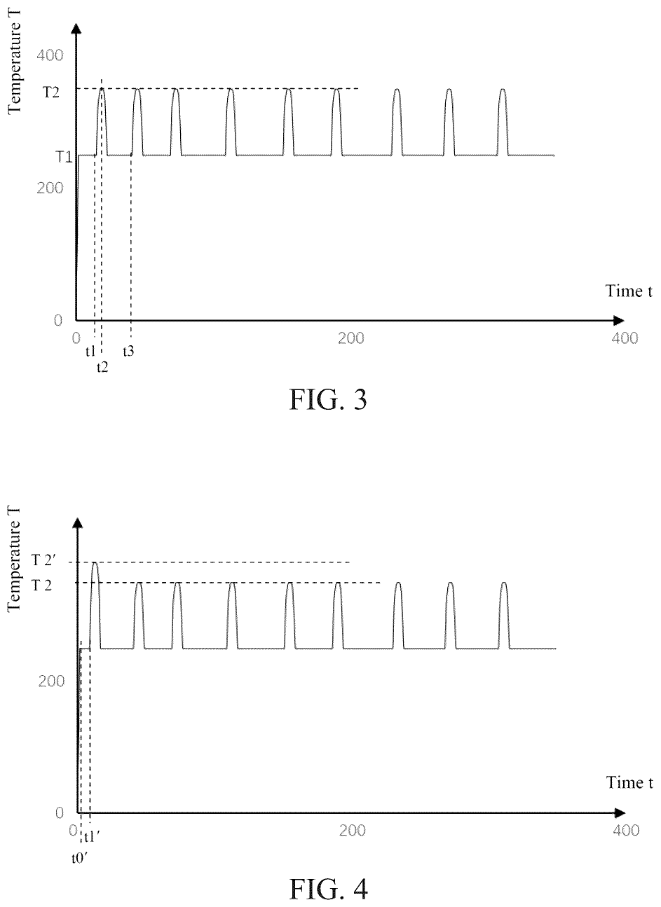

In this step, heating may be started by long-pressing a button on the heat-not-burn device, or heating may be started automatically when it is detected that an aerosol-forming substrate is inserted. In addition, when heating is started, with reference to FIG. 3, the heating element is controlled to increase from the initial temperature to the first temperature T1 within a time period 0 to t1, and is maintained at the first temperature T1. The first temperature T1 is 100° C. to 300° C. (including two endpoint values and any value between the endpoint values), and is preferably controlled to 180° C. to 280° C. (including two endpoint values and any value between the endpoint values). In addition, the heating element increases from the initial temperature to the first temperature T1 very quickly, and the time may be within 3 s, 2 s, or even 0.5 s, to preheat the aerosol-forming substrate. The length of the preheat time is not fixed. The aerosol-forming substrate is maintained at the first temperature T1 as long as the user does not vape. In some embodiments, T1 may be 190° C., 200° C., 210° C., 220° C., 230° C., 240° C., 250° C., 260° C., or 270° C.
Step S20: Control the heating element to increase from a current temperature to a second temperature when detecting a vaping action, where the second temperature is greater than the first temperature.

In this step, the vaping action of the user may be detected by the vaping detection module. With reference to FIG. 3, if the vaping action is detected at the moment t1, the heating element is controlled to continue to be heated, so that the temperature of the heating element reaches a second temperature T2 (T2>T1). The second temperature T2 is 300° C. to 400° C. (including two endpoint values and any value between the endpoint values). That is, the maximum value of T2 is 400° C., but T2 is not less than 300° C. Preferably, the second temperature is 300° C. to 380° C. (including two endpoint values and any value between the endpoint values). In some embodiments, T2 may be 300° C., 310° C., 320° C., 330° C., 340° C., 350° C., 360° C., 370° C., or 380° C.
Step S30: Control the heating element to decrease from a current temperature to a third temperature when detecting that the vaping action ends, where the third temperature is less than the second temperature.

In this step, the vaping action of the user may be detected by the vaping detection module. With reference to FIG. 3, if it is detected at a moment t2 that the vaping action ends, the heating element is controlled to start to decrease the temperature. The target temperature value may be the third temperature, and the heat of the heating element is preserved. The third temperature is 100° C. to 300° C. (including two endpoint values and any value between the endpoint values), and is preferably controlled to 180° C. to 280° C. (including two endpoint values and any value between the endpoint values). In this embodiment, the third temperature is the same as the first temperature T1. Certainly, in another embodiment, the third temperature may also be different from the first temperature T1. In some embodiments, the third temperature may be 190° C., 200° C., 210° C., 220° C., 230° C., 240° C., 250° C., 260° C., or 270° C.

According to the technical solutions of this embodiment, through temperature control on the heating element, low-temperature (the heating element is at the first temperature) preheating and low-temperature (the heating element is at the third temperature) heat preserving may be performed on the aerosol-forming substrate. High-temperature (the heating element is at the second temperature) heating is performed only when a vaping action occurs. Therefore, even if a user randomly vapes for a long time, during the low-temperature preheating and the low-temperature heat preserving, the aerosol-forming substrate is not mostly carbonized, and a small portion of the aerosol-forming substrate is lost. Therefore, the user is not required to complete vaping within approximately five minutes, so that the user can vape at any time and user experience is improved. In addition, it can be avoided that the aerosol-forming substrate is charred during continuous high-temperature heating, and the consistency of taste can be ensured. However, the heating element cannot be controlled in the foregoing manner in the prior art. Because the heating element is implemented through heat conduction in the prior art, and a heat capacity of the heating element is relatively large, the heat efficiency thereof is relatively low. The temperature of the low-temperature heat preserving needs to be higher than the heat preserving temperature of the present invention, and is generally greater than 300° C., for example, 330° C. However, because of the excessively high heat preserving temperature, the aerosol-forming substrate is subject to reaction excessively quickly during the interval between successive vaping. Consequently, a total vaping time is relatively short, and a user cannot vape as desired according to habits. In addition, heat is preserved at a relatively high temperature for a long time, heating is performed at a higher temperature, and temperature reduction of the heating element is relatively slow after vaping. As a result, a part of the aerosol-forming substrate is charred, or taste is inconsistent between successive vaping.

During actual temperature measurement and control, in some embodiments, the temperature measurement module actually detects a temperature of the heating element, and preferably, a temperature of the outer wall of the heating element. The temperature of the heating element is controlled to control a heating temperature of the aerosol-forming substrate. The temperature of the heating element is positively correlated to, but is not necessarily completely the same as the temperature of the aerosol-forming substrate. That is, in some embodiments, the temperature of the heating element is used to represent the heating temperature of the aerosol-forming substrate.

It should be noted that, the vaping action may be detected by a vaping detection module such as a microphone, or may be detected through temperature detection, heat capacity detection, photosensitive detection, pressure detection, or the like.

Further, in an optional embodiment, the heating element heats the aerosol-forming substrate through infrared radiation. A wavelength of infrared light is mainly 2 μm to 4.75 μm (including two endpoint values and any value between the endpoint values). It can be understood that heat conduction heating also exists during infrared light heating.

In a heating manner of infrared radiation, in a specific embodiment, the heating element includes a heating body and a tube element, the heating body includes a heating substrate and an infrared radiation layer disposed on an outer surface of the heating substrate, the heating substrate is configured to be powered on for heating and excite the infrared radiation layer to radiate infrared light, the heating body is at least partially spaced from the tube wall of the tube element, the tube wall of the tube element allows the infrared light to penetrate through, and the infrared light is configured to heat the aerosol-forming substrate. The entire heating body may be a single-spiral structure, a double-spiral structure, or an N-shaped structure formed by winding a heating wire, or may be a barrel, a sheet, or a column. A heating principle is as follows: The heating element heats the aerosol-forming substrate mainly through infrared light of the infrared radiation layer, and heat conduction of the heating element assists in the heating. Different from an existing heating element, a temperature of the heating body in this solution reaches a maximum of 1300° C., is generally 500° C. to 1000° C., and is preferably 600° C. to 800° C. in a steady heating process (a local temperature of the heating element in the prior art is approximately a maximum of 420° C.). In this temperature range, the infrared radiation layer mainly radiates light waves having a wavelength of 2 μm to 14 μm (including endpoint values and any value between the endpoint values), which is a band range easily absorbed by the aerosol-forming substrate. In particular, a band of 2 μm to 4.75 μm (including endpoint values and any value between the endpoint values) has high energy density, which enables the aerosol-forming substrate to increase the temperature rapidly.

The heating body is heated above 500° C. instantly (1 to 3 seconds), or even above 1000° C., to excite the infrared radiation layer to radiate the infrared light. Therefore, the infrared light rapidly heats the aerosol-forming substrate. Because of the rapid heating, the preheat temperature and the heat preserving temperature may be set to be as low as possible. In this way, a very small part of the aerosol-forming substrate is consumed in the preheat stage and the heat preserving stage. A vaping time of the aerosol-forming substrate may be very long, and a user may have a very long break between successive vaping, satisfying a requirement that a user vapes at any time and reducing the requirement on a vaping time of the user. In addition, the taste of the vaping is not affected, and the experience is greatly improved. In addition, light waves have strong penetration performance and ensure uniform heating, and energy is not excessively accumulated at a point or a surface. Therefore, aerosols can be rapidly generated without burning, thereby ensuring taste.

In addition, a gap is at least partially reserved between the heating body and the tube element (for example, a quartz tube). Preferably, the heating body is completely not in contact with the tube element. A temperature of the heating body may be as high as 1300° C., is generally controlled as 500° C. to 1000° C., and is preferably 600° C. to 800° C. in a steady heating process. The entire vaping process may be divided into two main stages:

Preheat stage: A preheat time is very short, to achieve rapid aerosol generation, and usually a user can vape within approximately 3 seconds. This is because the heating body can be rapidly heated to above 500° C., most of the energy is infrared light radiated by the heating body, and the wavelength is mainly concentrated in 2 μm to 14 μm, especially, 2 μm to 4.75 μm, and the radiation energy is absorbed by the aerosol-forming substrate to rapidly heat up. Besides, some of the energy is heat-conducted to the quartz tube with air as a medium, and after the quartz tube heats up, the energy is then heat-conducted to the aerosol-forming substrate (this energy occupies a small proportion in the preheat stage). Other energy is radiated in a form of light waves, and then is absorbed by the quartz tube to increase the temperature, and infrared light mainly having the 8 μm to 11 μm wavelength is radiated to the outside. Therefore, the aerosol-forming substrate quickly generates aerosols because the aerosol-forming substrate absorbs light waves of the 2 μm to 14 μm wavelength to generate heat (mainly including bands of 2 μm to 4.75 μm and 8 μm to 11 μm), which is much more efficient than direct heat conduction. At the same time, the heat conduction and radiation of the quartz tube also have impact to some extent.

Steady heating stage: After the preheat stage, a user is prompted to vape after 3 seconds. If the user does not vape, a controller controls the heating element to run at a low power after approximately 6 seconds. In this case, because the heating element of this solution has a relatively small heat capacity, temperature reduction is quick. After the power is reduced, the temperature of the heating element may be quickly reduced. In this case, the energy of the light waves of the heating element that can be absorbed by the aerosol-forming substrate is also sharply reduced. In addition, the space between the heating body and the quartz tube greatly reduces heat conduction. Therefore, the temperatures of the aerosol-forming substrate and the quartz tube also quickly decrease. If vaping occurs at this time, rapid heating is performed to generate aerosols along with vaping, and the heat is preserved at a low temperature after the vaping is completed.

To achieve rapid aerosol generation, the heating body rapidly increases above 500° C., or even above 1000° C., and light waves mainly having a wavelength of 2 μm to 4.75 μm can enable the aerosol-forming substrate to rapidly generate aerosols. Because the light waves implement penetration and uniform heating, the aerosol-forming substrate is not charred. In addition, because of the gap between the heating body and the quartz tube, the temperature of the quartz tube decreases relatively quickly, and the temperature of a part of the aerosol-forming substrate in contact with the quartz tube does not excessively concentrate to cause charring of the e-cigarette. Therefore, rapid temperature increase can be achieved without smell of burning, that is, the user can vape at any time, and both fumes and taste can be ensured.

Further, in an optional embodiment, the heating control method of the present invention further includes:
controlling a first timer to start timing when heating is started;
controlling the first timer to stop timing when detecting the first vaping action, and determining a preheat time according to a time of the first timer; and
determining, according to the preheat time, the second temperature corresponding to the first vaping action, where the second temperature corresponding to the first vaping action is negatively correlated to a temperature increase time of the preheat time.

In this embodiment, when heating is started, the first timer may be started to record the preheat time. The preheat time is a time interval from starting the heating to occurrence of the first vaping action. In addition, a temperature increase time within the preheat time may be determined based on the temperature detected by the temperature measurement module. The second temperature corresponding to the first vaping action may be adjusted according to a temperature increase time within the preheat time before the vaping. Specifically, a shorter temperature increase time within the preheat time indicates a higher second temperature corresponding to the first vaping action, but the temperature does not exceed a specified maximum value of the second temperature, for example, 400° C. On the contrary, a longer temperature increase time within the preheat time indicates a lower second temperature corresponding to the first vaping action, but the temperature is not lower than a specified minimum value of the second temperature, for example, 300° C. In addition, it should be noted that, the temperature increase time herein may be determined according to a time recorded by the first timer, or may be a preset system time, for example, 3s, that is, it is preset that a temperature increase time in the preheat stage is 3s at a preset power output, and then heat is preserved at a reached instant temperature in the preheating. In the preheat stage after 3 s, the time recorded by the first timer does not affect determining of the second temperature.

In addition, it should be noted that, in the preheat stage, the aerosol-forming substrate is cold when being initially inserted, and it takes some time for the heating element to bake and uniformly heat the aerosol generation section of the aerosol-forming substrate. Assuming that the preheat time is insufficient, with reference to FIG. 4, the preheat time is 0 to t1′, and the temperature increase time is 0 to t0′, which is less than the temperature increase time shown in FIG. 3. Therefore, the higher second temperature T2′ is required for heating after the first vaping. If the preheat time is sufficient and the aerosol-forming substrate is uniformly heated, the second temperature may be correspondingly reduced.

Further, in an optional embodiment, the heating control method of the present invention further includes:
controlling a second timer to start timing when detecting that an (i-1)^{th} vaping action ends;
controlling the second timer to stop timing when detecting an i^{th} vaping action, and determining a heat preserving time according to a time of the second timer, where i=2, 3, . . .; and determining, according to the heat preserving time, the second temperature corresponding to the i^{th} vaping action, where the second temperature corresponding to the i^{th} vaping action is positively correlated to the heat preserving time.

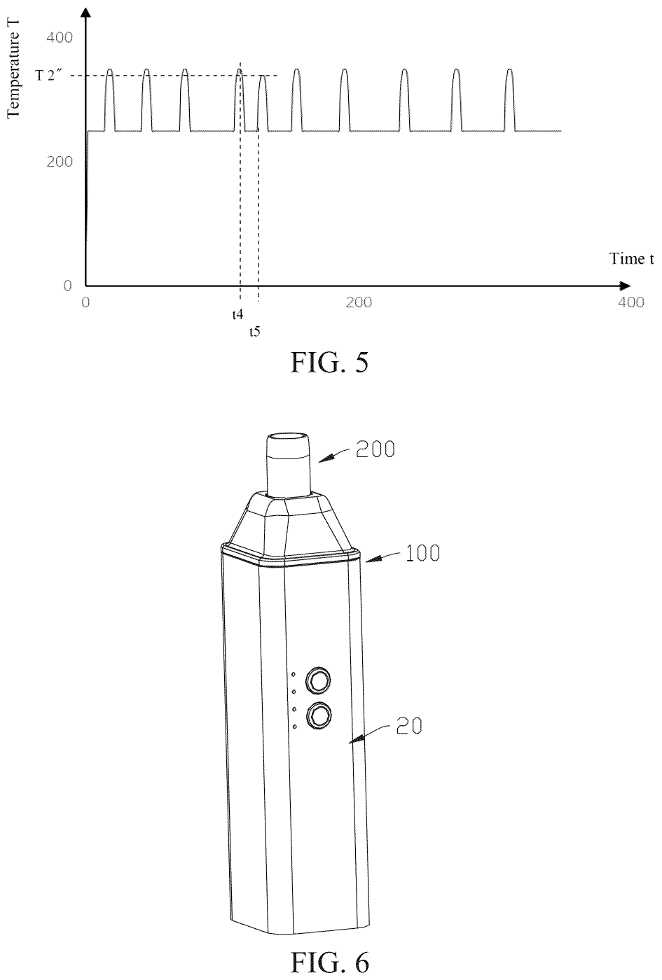

In this embodiment, during subsequent vaping, a heat preserving time between successive vaping, that is, a time interval between end of previous vaping and start of current vaping, is further recorded. In addition, the second temperature corresponding to the current vaping action may be adjusted based on the heat preserving time. Specifically, a longer heat preserving time indicates a higher second temperature corresponding to the current vaping action, but the temperature does not exceed a specified maximum value of the second temperature, for example, 400° C. On the contrary, if a heat preserving time is shorter, that is, vaping may occur when the temperature of the aerosol-forming substrate is not reduced to the third temperature, the heating temperature (the second temperature) required for current vaping is lower. As shown in FIG. 5, the heat preserving time before the current vaping action is t4 to t5, which is less than the heat preserving time before another vaping action. Therefore, the second temperature T2′ corresponding to the current vaping action is also lower, but the temperature is not lower than a specified minimum value of the second temperature, for example, 300° C.

In the foregoing two embodiments, it should be further noted that, although the second temperature corresponding to each vaping action changes with time, a change rule of the second temperature corresponding to the first vaping action is different from that of the second temperature corresponding to a subsequent vaping action. The second temperature corresponding to the first vaping action is negatively correlated to a temperature increase time within the preheat time, and the second temperature corresponding to the subsequent vaping action is positively correlated to a heat preserving time.

Further, in an optional embodiment, the heating control method of the present invention further includes:
collecting statistics on a current total number of times of vaping and/or an accumulated heating time when detecting that the vaping action ends; and
determining the third temperature according to the total number of times of vaping and/or the accumulated heating time.

In this embodiment, the third temperature may not be a fixed value, and may be adjusted based on the number of times of vaping and/or the accumulated heating time. Certainly, in another embodiment, the third temperature may also be set to a fixed value.

Further, in a specific embodiment, the step of determining, according to the preheat time, the second temperature corresponding to the first vaping action includes:
determining whether the temperature increase time of the preheat time is less than a first preset time, where the first preset time is, for example, 3s; and
determining the second temperature corresponding to the first vaping action as a first specific value if the temperature increase time is less than the first preset time, where the first specific value is, for example, 380° C.; or
determining the second temperature corresponding to the first vaping action as a second specific value if the temperature increase time is not less than the first preset time, where the second specific value is less than the first specific value, and the second specific value is, for example, 360° C.

Further, in a specific embodiment, the step of determining, according to the heat preserving time, the second temperature corresponding to the i^{th} vaping action includes:
determining whether the heat preserving time is less than a second preset time, where the second preset time is, for example, 3s; and
determining the second temperature corresponding to the i^{th} vaping action as a third specific value if the heat preserving time is less than the second preset time, where the third specific value is, for example, 350° C.; or
determining the second temperature corresponding to the i^{th} vaping action as a fourth specific value if the heat preserving time is not less than the second preset time, where the fourth specific value is greater than the third specific value, and the fourth specific value is, for example, 360° C.

Further, in an optional embodiment, the step of controlling the heating element includes:
obtaining, in real time, the temperature detected by the temperature measurement module, to obtain the detected temperature value, where in some embodiments, in this step, the temperature detected by the temperature measurement module may be a temperature of the heating element, or may be a temperature of a heating cavity, or may be a temperature of the inner wall of the heating cavity, in a specific embodiment, the temperature measurement module is a temperature measurement film, where the temperature measurement film is adhered to the wall of a quartz tube, or is a temperature measurement probe disposed inside the quartz tube, and it should be noted that the first temperature, the second temperature, and the third temperature in the foregoing control method are temperatures of a quartz tube in some embodiments; and
obtaining the target temperature value, where the target temperature value is the first temperature when heating is started; the target temperature value is the second temperature when the vaping action is detected; and the target temperature value is the third temperature when it is detected that the vaping action ends; and
performing PID calculation on the detected temperature value and the target temperature value, and controlling the heating element according to a PID calculation result.

In this embodiment, the temperature detected by the temperature measurement module may be used as a detected temperature value, and the target temperature value in each stage is determined. Preferably, the target temperature value dynamically changes. Then, the detected temperature value and the target temperature value may be inputted as PID, heating control information is outputted after PID operation, and finally heating control is performed on the heating element according to the heating control information.

Further, in an optional embodiment, the heating control method of the present invention further includes:
stopping control on the heating element when determining that a preset stop condition is met, where the preset stop condition includes at least one of the following:
a number of times of vaping reaches a preset number of times, where the preset number of times is, for example, 10 to 16;
an accumulated heating time reaches a third preset time, where the third preset time is, for example, 5 to 60 minutes; and
a stop instruction inputted by a user is received.

In this embodiment, when the total number of times of vaping reaches a specified number of times, or an entire vaping time exceeds a preset time, or a user inputs a stop instruction (for example, long-presses a button on an e-cigarette), heating of the heating element may be stopped.

It should be noted that, the value ranges in the foregoing embodiments all include endpoint values.

The present invention further constructs a computer storage medium, the computer storage medium storing a computer program, where the computer program, when executed by a processor, implements the steps of the heating control method of a heat-not-burn device described above.

The computer-readable storage medium of the present invention may be various computer-readable storage mediums capable of storing program code, such as a USB flash drive, a removable hard disk, a read-only memory (ROM), a magnetic disk, or an optical disc.

The present invention further constructs a heat-not-burn device, including a processor and a memory storing a computer program, where when executing the computer program, the processor implements the steps of the heating control method of a heat-not-burn device described above.

The processor of the present invention is configured to provide computing and control capabilities, to support operation of the entire heat-not-burn device. It should be understood that in the embodiments of the present application, the processor can be a central processing unit (CPU), or may be another general-purpose processor, a digital signal processor (DSP), an application-specific integrated circuit (ASIC), a field programmable gate array (FPGA) or another programmable logic device, a discrete gate or transistor logic device, or a discrete hardware component, or the like. The general-purpose processor may be a microprocessor, or the processor may be any conventional processor or the like.

FIG. 6 is a structural diagram of a heat-not-burn device according to a first embodiment of the present invention. A heat-not-burn device 100 of this embodiment may heat an aerosol-forming substrate 200 in a heat-not-burn manner, and has good atomization stability and good atomization taste. In some applications, the aerosol-forming substrate 200 may be provided on the heat-not-burn device 100 in a pluggable manner. The aerosol-forming substrate 200 may be columnar. Specifically, the aerosol-forming substrate may be a solid material in the shape of a filament or sheet or an integral form made of leaves and/or stalks of a plant, and an aroma component may be further added to the solid material.

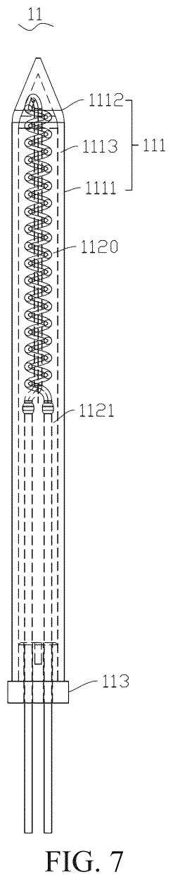

As shown in FIG. 6 and FIG. 7, further, in this embodiment, the heat-not-burn device 100 includes a heating element 11 and a power supply component 20. The heating element 11 may be partially inserted into the aerosol-forming substrate 200. Specifically, the heating element may be partially inserted into a medium segment of the aerosol-forming substrate 200, and infrared light waves are generated in a powered-on state to heat the medium segment of the aerosol-forming substrate 200, so that the aerosol-forming substrate is atomized to generate aerosols. The heating element 11 has the advantages of simple structure, high atomization efficiency, strong stability, and long service life. The power supply component 20 is configured to supply power to the heating element 11.

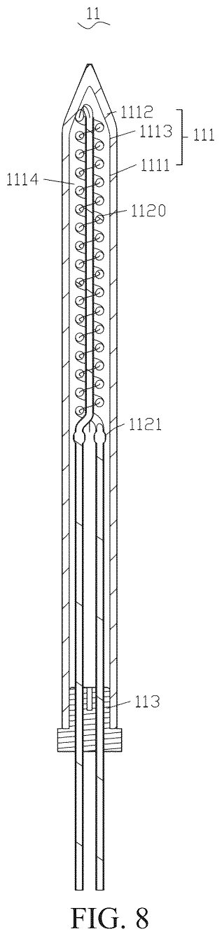

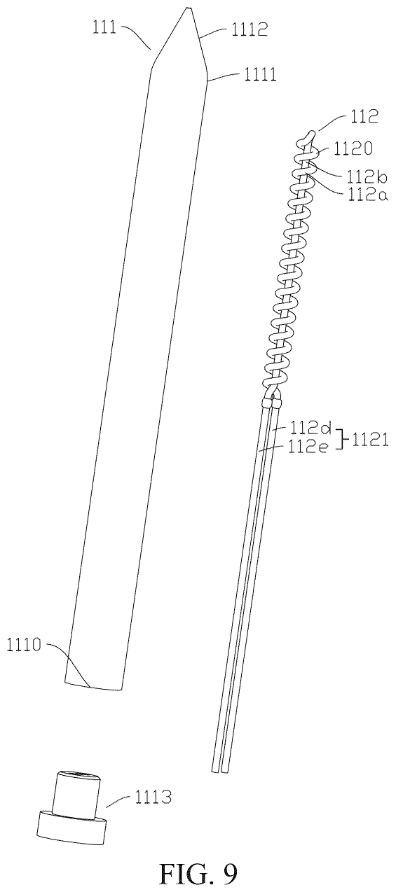

As shown in FIG. 7 to FIG. 9, in this embodiment, the heating element 11 includes a tube element 111, a heating body 112, and a base 113. The tube element 111 is accommodated in at least a part of the heating body 112, and may allow light waves to penetrate into the aerosol-forming substrate 200. Specifically, in this embodiment, the tube element 111 may allow infrared light to penetrate through, so that the heating body 112 may radiate infrared light to heat the aerosol-forming substrate 200. The base 113 is disposed at an opening 1110 of the tube element 111, and is configured to fix the tube element 111.

In this embodiment, the heating body 112 includes a heating substrate and an infrared radiation layer. The heating substrate is powered on for heating according to the foregoing heating control method. In a powered-on heating state, the heating substrate may excite the infrared radiation layer to generate and radiate infrared light. The infrared radiation layer is disposed on the outer surface of the heating substrate.

In some embodiments, the heating body 112 includes a heating substrate and an infrared radiation layer covering the exterior of the heating substrate. The heating substrate includes a metal substrate with high-temperature anti-oxidation performance, such as a metal wire. The heating substrate may be a nickel-chromium alloy substrate (such as nickel-chromium alloy wire), iron-chromium-aluminum alloy substrate (such as iron-chromium-aluminum alloy wire) or the like made of a metal material with good high-temperature anti-oxidation performance, high stability, and good deformation resistance. In some embodiments, the diameter of the metal wire may be 0.15 mm to 0.8 mm (including two endpoint values and any value between the endpoint values). In addition, the metal wire (the heating substrate) may be bent or wound to form a heating portion of various shapes. For example, as shown in FIG. 7 to FIG. 9, the metal wire may be bent to form a heating portion 1120 having a spiral cylindrical shape. It may be understood that in some other embodiments, the heating substrate may be wound to form a heating portion having a single-spiral shape, a double-spiral shape, an M shape, an N shape, or other shapes.

In some embodiments, the heating body further includes an anti-oxidation layer, and the anti-oxidation layer is formed between the heating substrate and the infrared radiation layer. Specifically, the anti-oxidation layer may be an oxide film. The heating substrate is subject to high-temperature heat treatment, a dense oxide film is formed on the surface of the heating substrate, and the oxide film forms the anti-oxidation layer. Certainly, it may be understood that, in some other embodiments, the anti-oxidation layer is not limited to including the oxide film formed by itself. In some other embodiments, the anti-oxidation layer may be an anti-oxidation coating applied to the outer surface of the heating substrate. The thickness of the anti-oxidation layer may be selected as 1 μm to 150 μm (including two endpoint values and any value between the endpoint values).

In some embodiments, the infrared radiation layer may be an infrared layer. The infrared layer may be formed on a side of the anti-oxidation layer away from the heating substrate by an infrared-layer-forming substrate through high-temperature heat treatment. Specifically, the infrared-layer-forming substrate may be silicon carbide, spinel, or a composite substrate thereof. Certainly, it may be understood that, in some other embodiments, the infrared radiation layer is not limited to being the infrared layer. In some other embodiments, the infrared radiation layer may be a composite infrared layer. Specifically, the infrared layer may be formed on a side of the anti-oxidation layer away from the heating substrate through dip coating, spray coating, brush coating, and other methods. The thickness of the infrared radiation layer may be 10 μm to 300 μm (including two endpoint values and any value between the endpoint values).

In this embodiment, the tube wall of the tube element 111 is spaced from the entire heating body 112. For example, a gap 1114 is reserved between the tube element 111 and the heating body 112. The gap 1114 may be filled with air (that is, air inside and outside the tube element is connected). Certainly, it may be understood that, in some other embodiments, the gap 1114 may also be filled with a reducing gas or an inert gas. By reserving the gap 1114, there is no direct contact between the tube element 111 and the heating body 112. In some embodiments, the heating body 112 may also be partially spaced from the tube wall of the tube element 111. Specifically, the heating body 112 includes a heating portion 1120. The radial dimension of a partial segment of the heating portion 1120 may be greater than the radial dimension of another partial segment, and the radial dimension of a partial segment of the heating portion 1120 may be equal to the inner diameter of the tube element 111, thereby achieving a position limiting function. Certainly, it may be understood that, in some embodiments, the inner side of the tube element 111 may partially project towards the heating body 112 to be in contact with the heating body 112, thereby achieving a position limiting function. Certainly, it may be understood that, in some other embodiments, an isolating and positioning structure may be provided on the heating body 112 or the tube wall of the tube element 111, so that the heating body 112 is not in direct contact with the tube wall of the tube element 111. For example, a ceramic ring is sleeved on a partial segment of the heating body 112. It needs to be noted that the foregoing gap may be a gap accessible to air, and does not mean that air or another gas necessarily exists. A vacuum state is also a form of the gap.

In this embodiment, the heating portion 1120 includes a first heating portion 112a and a second heating portion 112b, and one end of the first heating portion 112a is connected to one end of the second heating portion 112b. The first heating portion 112a and the second heating portion 112b are of an integrally formed structure, and may be formed by bending and winding one or two heating wires. It may be understood that, in some other embodiments, the first heating portion 112a and the second heating portion 112b may also be of a split structure, and the first heating portion 112a and the second heating portion 112b may be two heating wires respectively. It may be understood that, in some other embodiments, the second heating portion 112b may also be omitted, or may be replaced by a non-heating conductive rod.

In addition, the heating body 112 further includes a conductive portion 1121 provided at one end of the heating portion 1120. The conductive portion 1121 is connected to the heating portion 1120, may be led out from one end of the tube element 111, and may penetrate out of the base 113 to be conductively connected to the power supply component 20. The conductive portion 1121 may be fixed to the heating portion 1120 through welding. Certainly, it may be understood that, in some other embodiments, the heating portion 1120 may be integrally formed with the conductive portion 1121, and a first free end 112d and a second free end 112e of the heating body 112 may separately form two conductive portions 1121. That is, the first free end 112d of the first heating portion 112a forms one of the conductive portions 1121; and the second free end 112e of the second heating portion 112b forms the other conductive portion 1121. In some other embodiments, the conductive portion 1121 may be a lead wire that may be welded to the heating portion 1120. Certainly, it may be understood that, in some other embodiments, the conductive portion 1121 is not limited to a lead wire, and may be other conductive structures.

In this embodiment, the tube element 111 may be a quartz glass tube. Certainly, it may be understood that, in some other embodiments, the tube element 111 is not limited to a quartz tube, and may be another window material that may allow light waves to penetrate through, for example, transparent infrared glass, transparent ceramics, or diamond.

In this embodiment, the tube element 111 is a hollow tube with a circular cross-section, and has two ends distributed along the axial direction, and is configured to be at least partially inserted into the aerosol-forming substrate 200. Specifically, the tube element 111 includes a body portion 1111 and a tip portion 1112 disposed at one end of the body portion 1111, and the heating body 112 is spaced from the inner wall of the body portion 1111. Certainly, it may be understood that, in some other embodiments, the cross-section of the tube element 111 is not limited to being circular. For example, the tube element may be a triangular prism (with a triangular cross-section), a flat plate (with a rectangular cross-section), a column with an elliptic cross-section, or a tube of another shape. The body portion 1111 is a hollow structure provided with an opening 1110 at one end. The tip portion 1112 is provided at one end of the body portion 1111 away from the opening 1110. By providing the body portion 1111, the heating element 11 is at least partially inserted into and removed from the aerosol-forming substrate 200 conveniently. In this embodiment, a first accommodating cavity 1113 is formed on an inner side of the tube element 111, and the first accommodating cavity 1113 is a columnar cavity. In some other embodiments, the heating body 112 may be spaced on the periphery of the tube element 111, and a second accommodating cavity for accommodating the aerosol-forming substrate 200 may be formed on the inner side of the tube element 111.

In this embodiment, the top of the heating body 112 is at least partially in contact with the inner wall surface of the tip portion 1112. In this way, while the end of the heating body 112 close to the tip portion 1112 has a position limiting function for installation, it can be ensured that the lower part of the heating body 112 is not in direct contact with the inner wall of the tube element 111. In addition, a heat dissipation area can be increased, and an excessively high temperature of the end of the heating portion 1120 close to the tip portion 1112 can be avoided.

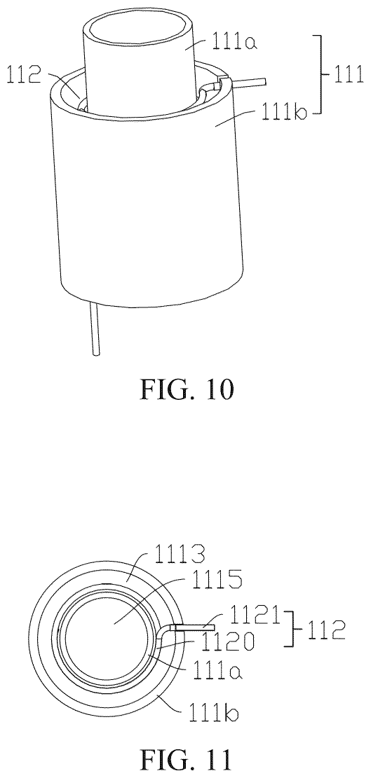

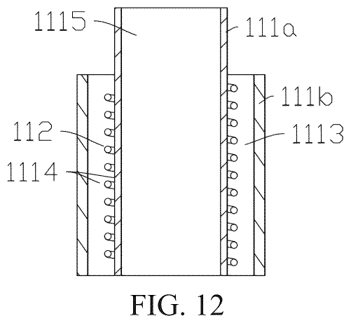

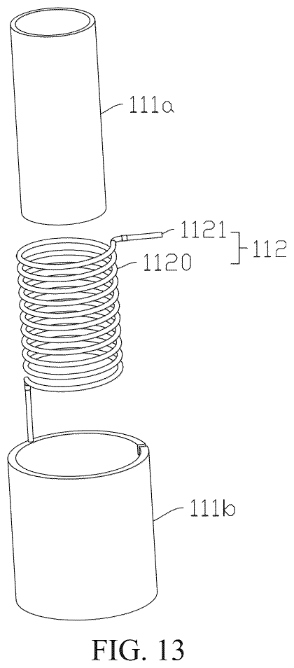

FIG. 10 to FIG. 13 show a heating element in a heat-not-burn device according to another embodiment of the present invention. A difference from the foregoing embodiment lies in that the heating element 11 is not limited to being partially inserted into the aerosol-forming substrate 200 to heat the aerosol-forming substrate 200. In this embodiment, the heating element 11 may be sleeved on the periphery of a medium segment of the aerosol-forming substrate 200. Besides, the heating body 112 is disposed on the periphery of the tube element 111, and an accommodating cavity is provided inside the tube element 111. The aerosol-forming substrate is at least partially accommodated in the accommodating cavity. In this embodiment, the aerosol-forming substrate 200 is heated through circumferential heating.

In this embodiment, the tube element 111 includes a first tube element 111a and a second tube element 111b, and the first tube element 111a is a hollow structure with two ends in communication with each other. In addition, the first tube element 111a can be cylindrical and has an inner diameter that may be slightly larger than the outer diameter of the aerosol-forming substrate 200. A second accommodating cavity 1115 may be formed on the inner side of the first tube element 111a and configured to accommodate the aerosol-forming substrate 200 and form a heating space allowing the medium segment of the aerosol-forming substrate 200 to be heated. The axial length of the first tube element 111a may be greater than the axial length of the second tube element 111b. The second tube element 111b may be sleeved on the periphery of the first tube element 111a. The second tube element 111b may be cylindrical. The radial dimension of the second tube element 111b may be greater than that of the first tube element 111a. That is, a gap is reserved between the second tube element 111b and the first tube element 111a. The gap may form the first accommodating cavity 1113. The first accommodating cavity 1113 is configured to accommodate the heating body 112. In some embodiments, the heating body 112 is wound around the periphery of the first tube element 111a, and a gap 1114 is reserved between the entire heating body and the inner wall of the second tube element 111b as well as the outer wall of the first tube element 111a, so that a temperature difference may be formed between the inner wall of the first accommodating cavity 1113 and the heating body 112, thereby achieving a heat insulation function. In some embodiments, a reflective layer may be provided on the inner wall of the second tube element 111b, and configured to reflect heat of the heating body 112 and radiate the heat to the aerosol-forming substrate 200, thereby enhancing the energy efficiency of heating.

In some other embodiments, the heating body 112 is not limited to being completely spaced from the first tube element 111a or the second tube element 111b. In some other embodiments, the heating body 112 may be partially spaced from the first tube element 111a, and the radial dimension of a partial segment of the heating portion 1120 may be similar to the outer diameter of the first tube element 111a, achieving a position limiting function. In some embodiments, the heating body 112 may also be partially spaced from the second tube element 111b, and the radial dimension of a partial segment of the heating portion 1120 may be similar to the radial dimension of the second tube element 111b.

In some embodiments, the heating element may alternatively be a plasma heating element. Specifically, both the plasma heating element and a laser heating element are central heating structures. That is, the heating element is at least partially inserted into the aerosol-forming substrate. The plasma structure generally includes a glass tube and two electrodes located in the glass tube. The two electrodes are spaced from each other. After the two electrodes are powered on, a high voltage is generated between the electrodes and a gas medium is ionized, to form a high-voltage arc to generate heat. Therefore, the foregoing method is also applicable to a device of a plasma structure, or another heating element that is heated by using optical waves and whose operating temperature may be higher than 500° C.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating control method for a heat-not-burn device that includes a heating element for heating an aerosol-forming substrate, the method comprising:
controlling the heating element so as to increase from an initial temperature to a first temperature when heating is started, and maintaining the first temperature;
controlling the heating element so as to increase from a current temperature to a second temperature when detecting a puffing action, the second temperature being greater than the first temperature; and
controlling the heating element so as to decrease from a current temperature to a third temperature when detecting that the puffing action ends, the third temperature being less than the second temperature.

2. The heating control method of claim 1, wherein the heating element heats the aerosol-forming substrate through infrared radiation,
wherein the heating element comprises a heating body and a tube element,
wherein the heating body comprises a heating substrate and an infrared radiation layer disposed on an outer surface of the heating substrate,
wherein the heating substrate is configured to be powered on for heating and exciting the infrared radiation layer to radiate infrared light,
wherein the heating body is at least partially spaced from a tube wall of the tube element,
wherein the tube wall of the tube element allows the infrared light to penetrate through, and
wherein the infrared light is configured to heat the aerosol-forming substrate.

3. The heating control method of claim 2, wherein
the first temperature is 100° C. to 300° C.; and/or
the second temperature is 300° C. to 400° C.; and/or
the third temperature is 100° C. to 300° C.

4. The heating control method of claim 1, further comprising:
controlling a first timer to start timing when heating is started;
controlling the first timer to stop timing when detecting the first puffing action, and determining a preheat time according to a time of the first timer; and
determining, according to the preheat time, the second temperature corresponding to the first puffing action, the second temperature corresponding to the first puffing action being negatively correlated to a temperature increase time of the preheat time.

5. The heating control method of claim 1, further comprising:
controlling a second timer to start timing when detecting that an (i-1)^{th} puffing action ends;
controlling the second timer to stop timing when detecting an i^{th} puffing action, and determining a heat preserving time according to a time of the second timer, wherein i=2, 3, . . .; and
determining, according to the heat preserving time, the second temperature corresponding to the i^{th} puffing action, the second temperature corresponding to the i^{th} puffing action being positively correlated to the heat preserving time.

6. The heating control method of claim 1, further comprising:
collecting statistics on a current total number of times of vaping and/or an accumulated heating time when detecting that the puffing action ends; and
determining the third temperature according to the total number of times of vaping and/or the accumulated heating time.

7. The heating control method of claim 4, wherein determining, according to the preheat time, the second temperature corresponding to the first puffing action comprises:
determining whether the temperature increase time of the preheat time is less than a first preset time; and
determining the second temperature corresponding to the first puffing action as a first specific value if the temperature increase time is less than the first preset time, or determining the second temperature corresponding to the first puffing action as a second specific value if the temperature increase time is not less than the first preset time,
wherein the second specific value is less than the first specific value.

8. The heating control method of claim 5, wherein determining, according to the heat preserving time, the second temperature corresponding to the i^{th} puffing action comprises:
determining whether the heat preserving time is less than a second preset time; and
determining the second temperature corresponding to the i^{th} puffing action as a third specific value if the heat preserving time is less than the second preset time, or determining the second temperature corresponding to the i^{th} puffing action as a fourth specific value if the heat preserving time is not less than the second preset time,
wherein the fourth specific value is greater than the third specific value.

9. The heating control method of claim 1, wherein controlling the heating element comprises:
obtaining, in real time, a temperature detected by a temperature measurement module, so as to obtain a detected temperature value;
obtaining a target temperature value, the target temperature value being the first temperature when heating is started, the second temperature when the puffing action is detected, and the third temperature when it is detected that the puffing action ends; and
performing PID calculation on the detected temperature value and the target temperature value, and controlling the heating element according to a PID calculation result.

10. The heating control method of claim 1, further comprising:
stopping control on the heating element when determining that a preset stop condition is met, the preset stop condition comprising at least one of the following:
a total number of times of vaping reaches a preset number of times,
an accumulated heating time reaches a third preset time, and
a stop instruction inputted by a user is received.

11. A heat-not-burn device, comprising:
a processor and a memory storing a computer program,
wherein when executing the computer program, the processor implements the heating control method of claim 1.

12. The heat-not-burn device of claim 1, further comprising:
a heating element; and
a power supply component,
wherein the heating element is partially insertable into a medium segment of the aerosol-forming substrate, and
wherein the heating substrate, in a powered-on state, is configured to generate infrared light waves to heat the medium segment of the aerosol-forming substrate.

13. A heating element, comprising:
a heating body; and
a tube element,
wherein the heating body is powered on for heating according to the heating control method of claim 1 and is configured to radiate infrared light,
wherein the heating body is at least partially spaced from a tube wall of the tube element,
wherein the tube wall of the tube element allows the infrared light to penetrate through, and
wherein the infrared light is configured to heat the aerosol-forming substrate.

14. The heating element of claim 13, wherein the heating body comprises a heating substrate and an infrared radiation layer disposed on an outer surface of the heating substrate, and
wherein the heating substrate is powered on for heating and is configured to excite the infrared radiation layer to radiate infrared light.

15. The heating structure of claim 14, wherein the heating substrate comprises a nickel-chromium alloy substrate or an iron-chromium-aluminum alloy substrate.

16. The heating structure of claim 14, wherein the heating substrate comprises a metal wire windable so as to form a heating portion having a single-spiral shape, a double-spiral shape, an M shape, an N shape, or other shapes.

17. The heating structure of claim 14, wherein the heating element includes an anti-oxidation layer, and
wherein the anti-oxidation layer is formed between the heating substrate and the infrared radiation layer.

18. The heating structure of claim 14, wherein a thickness of the infrared radiation layer ranges from 10 um to 300 um.

19. The heating element of claim 13, wherein the tube element is configured to be at least partially inserted into an aerosol-forming substrate and comprises a body portion and a tip portion disposed at one end of the body portion, and
wherein the heating body is spaced from an inner wall of the body portion.

20. The heating element of claim 13, wherein the heating body is disposed in a periphery of the tube element,
wherein an accommodating cavity is disposed in the tube element, and
wherein the aerosol-forming substrate is at least partially accommodated in the accommodating cavity.
